(19) United States
(12) Patent Application Publication
(10) Pub. No.: US 2011/0012952 A1
(43) Pub. Date: Jan. 20, 2011

(54) METHOD FOR PRINTING ON A WORKPIECE

(75) Inventors: YUAN-PING CHANG, Tu-Cheng (TW); CHING-HO WEI, Tu-Cheng (TW); LI-CHI PAI, Tu-Cheng (TW); CHANG-CHIN WU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/683,578

(22) Filed: Jan. 7, 2010

(30) Foreign Application Priority Data
Jul. 14, 2009 (CN) 200910157570.0

(51) Int. Cl. B41J 29/38

(52) U.S. Cl. 347/16

(57) ABSTRACT

A three-dimensional continuous printing method on a workpiece positioned on a rotation mechanism is described. The rotation mechanism rotates the print area of the surface of the workpiece to face the inkjet head of the printer. The inkjet head of the printer prints on the print area of the surface of the workpiece. A selection of additional print areas is offered. If the selection is requested, the rotation mechanism rotates the workpiece such that the desired print area faces the inkjet head of the printer, and selection of the other print area of the workpiece for print is confirmed. If not, the printing process is completed.

### BACKGROUND

1. Technical Field

The disclosure generally relates to printing systems, and particularly to a method for printing on a workpiece.

2. Description of Related Art

Computer printers generally work with sheet media such as paper or transparencies. Because the printing surface of the paper is planar, distances from ink nozzles of the printer to the printing surface are constant.

The printer cannot print on three-dimensional surfaces, due to the varying distance from nozzles to surface. This results in image distortion and generally poor print quality.

What is needed, therefore, is a method for printing on a workpiece addressing the limitations described.

### BRIEF DESCRIPTION OF THE DRAWINGS

FIG. 1 is a perspective view of one embodiment of a printing system, showing one embodiment of a method for printing on a workpiece.

FIG. 2 is a diagram of each print area of the workpiece.

FIG. 3 is a block diagram of a method for printing on a workpiece in accordance with one embodiment.

FIG. 4 is a sectional view of the printing system of FIG. 1, showing a rotation mechanism rotating a print area of a workpiece to face an inkjet head of a printer.

FIG. 5 is a sectional view of the printing system of FIG. 1, showing the inkjet head of the printer printing on the print area of the workpiece.

FIG. 6 is a sectional view of the printing system of FIG. 1, showing the inkjet head of the printer printing on another print area of the workpiece.

### DETAILED DESCRIPTION OF THE EMBODIMENTS

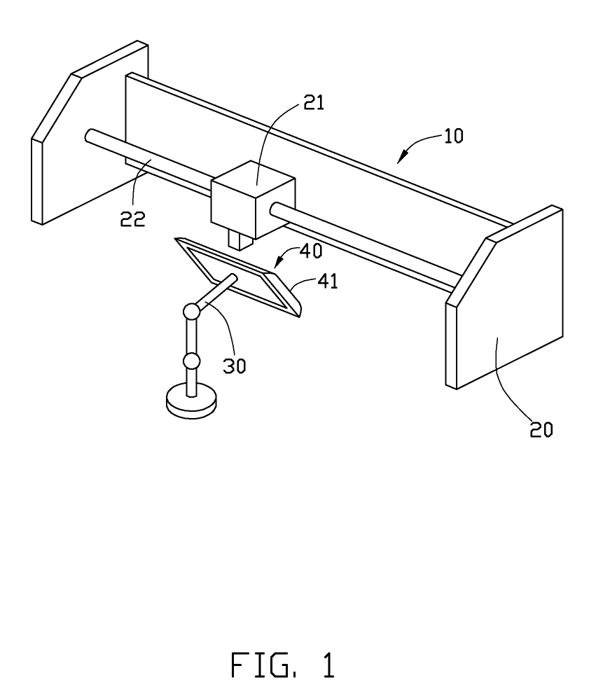

Referring to FIG. 1, one embodiment of a printing system employing one embodiment of a method of printing on a workpiece is shown. The printing system 10 including a printer 20 and a rotation mechanism 30. The printer 20 includes an inkjet head 21 and a slide rail 22. The inkjet head 21 is disposed on a slide rail 22, allowing lateral movement to print an image on a surface 41 of a workpiece 40.

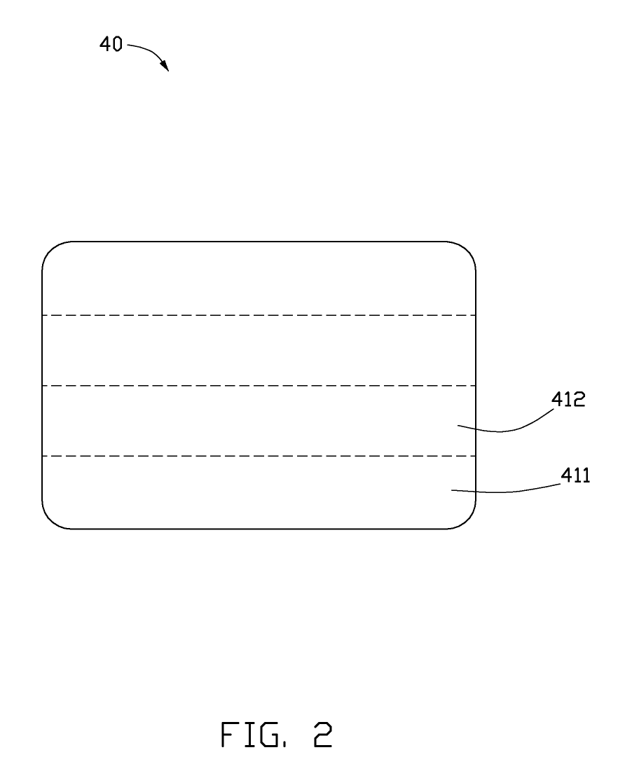

Referring to FIG. 2, the surface 41 of the workpiece 40 is separated into a plurality of separated print areas 411, 412 according to a printing scope of the inkjet head 21. The workpiece 40 is positioned on the rotation mechanism 30. The rotation mechanism 30 rotates each separated print areas 411, 412 of the surface 41 of the workpiece 40 to face the inkjet head 21.

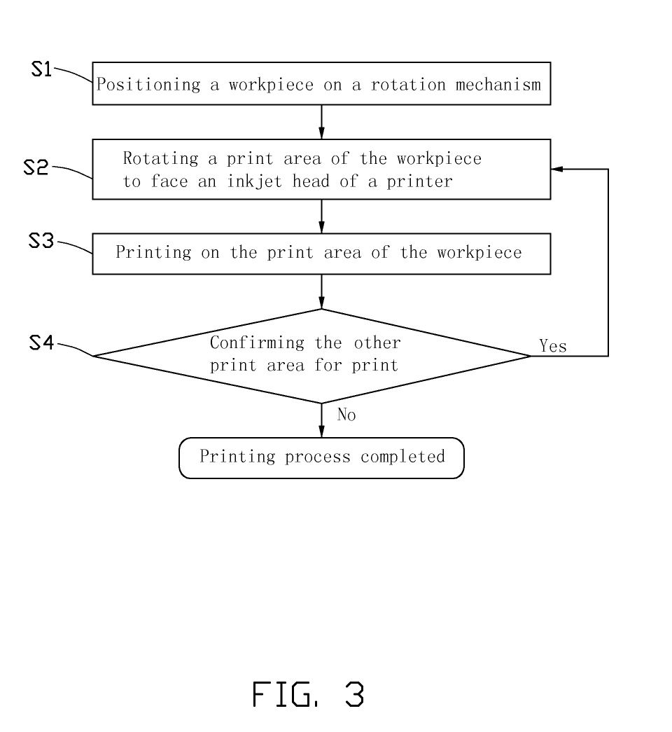

Referring to FIG. 3, the method proceeds as follows.

In Step S1, the workpiece 40 is positioned on the rotation mechanism 30. The rotation mechanism 30 is configured for rotating the workpiece 40. Here, the rotation mechanism 30 is a robot arm.

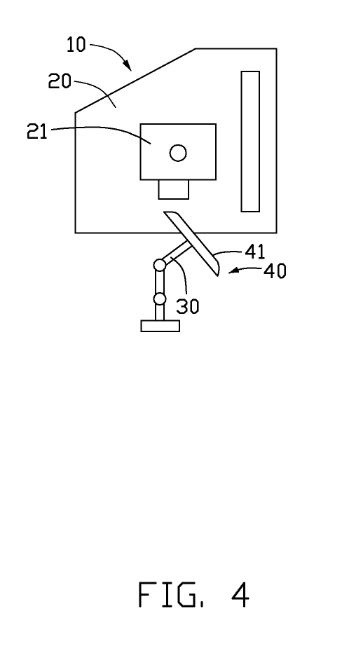

In Step S2, the rotation mechanism rotates the print area of the surface of the workpiece to face the inkjet head of the printer. FIG. 4 shows the inkjet head 21 of the printer 20 situated to print on the print area 411 of the surface 41 of the workpiece 40. The rotation mechanism 30 rotates the print area 411 of the surface 41 of the workpiece 40 to face the inkjet head 21 of the printer 20. The print area 411 is then within the printing scope of the inkjet head 21 of the printer 20.

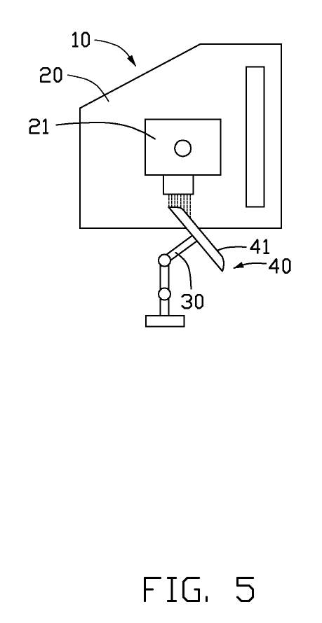

In Step S3, the inkjet head of the printer prints on the print area of the surface of the workpiece. Referring to FIG. 5, after the rotation mechanism 30 rotates the print area 411 of the surface 41 of the workpiece 40 to face the inkjet head 21 of the printer 20, the rotation mechanism 30 is fixed. The inkjet head 21 of the printer 20 prints on the print area 411 of the surface 41 of the workpiece 40.

In Step S4, a selection of additional print areas is offered. If one is chosen, step 2 is implemented, and selection of the other print area 412 of the surface 41 of the workpiece 40 for print is confirmed. If not, the printing process is completed.

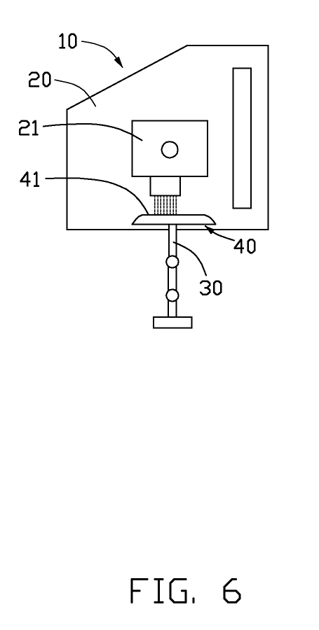

Referring to FIG. 6, in step S2, the rotation mechanism 30 rotates the print area 412 of the surface 41 of the workpiece 40 to face the inkjet head 21 of the printer 20. In step 3, the inkjet head 21 of the printer 20 prints on the print area 412 of the surface 41 of the workpiece 40.

It should be noted that the rotation mechanism 30 rotates each print area 411, 412 of the surface 41 of the workpiece 40 to face the inkjet head 21. The inkjet head 21 of the printer 20 prints on each separated print area 411, 412 of the surface 41 of the workpiece 40, one separated print area at a time, after each separated print area is rotated to face the inkjet head 21 of the printer 20. Thus, the method has achieved three-dimensional continuous printing.

It is to be understood that the present disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for printing on a workpiece, the method comprising:
providing a printing system, the printing system comprising a rotation mechanism and a printer;
positioning the workpiece on the rotation mechanism;
rotating a print area of the workpiece to face an inkjet head of the printer; and
printing on the print area of the workpiece.

2. The method as claimed in claim 1, wherein the print area can be separated into a plurality of separated print areas according to a printing scope of the inkjet head.

3. The method as claimed in claim 2, wherein the rotation mechanism rotates each separated print area of the workpiece to face the inkjet head.

4. The method as claimed in claim 3, wherein the printer prints on each separated print area, one separated print area at a time, after each separated print area is rotated to face the inkjet head of the printer.

5. The method as claimed in claim 1, wherein the rotation mechanism is a robot arm.

6. The method as claimed in claim 1, wherein the inkjet head is disposed on a slide rail, thereby allowing the inkjet head to move laterally to print an image on the print area of the workpiece.

7. A method for printing on a workpiece, the method comprising:
providing a printing system, the printing system comprising a rotation mechanism and a printer;
positioning the workpiece on the rotation mechanism;
rotating a plurality of print areas of the workpiece, one print area at a time, to face an inkjet head of the printer; and printing on the print areas of the workpiece, one print area at a time.

8. The method as claimed in claim 7, wherein the rotation mechanism is a robot arm.

9. The method as claimed in claim 7, wherein the inkjet head is disposed on a slide rail, thereby allowing the inkjet head to move laterally to print an image on the print areas of the workpiece.
